(19) United States
(12) Patent Application Publication
(10) Pub. No.: US 2005/0020798 A1
(43) Pub. Date: Jan. 27, 2005

(54) Method for producing prepolymers containing isocyanate groups and urethane groups

(76) Inventors: Thomas Bartz, Wiedenzhausen (DE); Hans Ulrich Schmidt, Petzenhausen (DE); Katrin Tietze, Schipkau (DE); Michael Ochse, Kaufungen (DE); Kai Thiele, Schwarzheide (DE); Imbridt Murrat, Senftenberg (DE)

Correspondence Address: Basf Corporation;Patent Department, 1609 Biddle Avenue, Wyandotte, MI, 48192, US

(21) Appl. No.: 10/496,746

(22) PCT Filed: Nov. 19, 2002
(86) PCT No.: PCT/EP02/12931

(30) Foreign Application Priority Data
Nov. 27, 2001 (EP) 101 57 768.0

(51) Int. Cl. C08G 18/00; C08G 18/30; C08G 18/38; C08G 18/48; C08G 18/52

(52) U.S. Cl. 528/76

(57) ABSTRACT

The invention relates to a method for producing prepolymers containing isocyanate groups and urethane groups. The inventive method comprises the following steps a) at least one polyisocyanate having a stoichiometric deficit of at least one t compound is reacted with at least two hydrogen atoms reacting with isocyanate groups, and b) the reaction product from step a) is distilled by means of a molecular evaporator.

The invention relates to a process for the preparation of prepolymers containing isocyanate and urethane groups, also referred to as NCO prepolymers, and the prepolymers obtainable by this process.

Prepolymers containing urethane groups and terminal isocyanate groups are important intermediates for the preparation of polyurethanes. They have been known for a long time and are extensively described in the literature.

Their preparation is carried out by reaction of compounds having at least two isocyanate-reactive hydrogen atoms with an excess of polyisocyanates. This reaction will usually leave unconverted monomer in the prepolymer. This is regarded as a disadvantage, since it reduces the utility of the prepolymers. For instance, some monomers, such as tolylene diisocyanate (TDI) or the aliphatic diisocyanates, have a low vapor pressure and a high toxicity. And, in the case of the isomers of diphenylmethane diisocyanate (MDI), the monomers can crystallize out in the prepolymer.

A range of measures are known which can reduce the level of monomer in the prepolymer.

U.S. Pat. No. 6,133,415 describes the demonomerization of prepolymers containing isocyanate and urethane groups by liquid-liquid extraction. However, this process is inefficient, and the extracted monomers must be separated from the extractant.

DE-A-196 16 046 describes a process for the separation of monomers or auxiliaries from organic polymers, in which the monomers are extracted from the polymers by means of compressed carbon dioxide. However, the demonomerization of prepolymers containing isocyanate and urethane groups, in particular those based on MDI, often results in damage to the product, for example discoloration or an increase in the molecular weight. Also, carbon dioxide often remains in the product, which can lead to problems in further processing.

A further possible method of separation of the monomers is distillation. Since prepolymers containing isocyanate and urethane groups are usually unstable at high temperatures, the distillation is preferably carried out with the use of azeotroping agents or preferably at reduced pressure, in particular by means of a thin-film evaporator.

WO 97/46603 describes a process for the removed of monomeric diisocyanates from prepolymers containing isocyanate and urethane groups by distillation, in which a mixture of organic solvents with differing boiling points is used as an azeotroping agent. However, the use of azeotroping agents makes the process more expensive, and the monomers must also be separated from the azeotroping agent before they can be used again.

EP-A-316 738 describes a process for the preparation of TDI-based prepolymer containing isocyanate and urethane groups that-has a low monomer content, in which the prepolymer is subjected to a thin-film distillation after its preparation. JP 9053522 describes a process for the preparation of prepolymers containing, isocyanate and urethane groups, which are likewise subjected to a thin-film distillation after their preparation. JP 08176252 and JP 08176253 describe prepolymers containing isocyanate and urethane groups and having a content of monomeric MDI of 0.15% by weight, which are subjected to a vacuum distillation after their preparation.

U.S. Pat. No. 5,202,001 describes a process for the demonomerization of prepolymers containing isocyanate and urethane groups, in particular those based on TDI, by thin-film evaporation in the presence of inert gases. This is said to suppress cleavage of the prepolymer backbone. U.S. Pat. No. 5,115,071 describes various techniques for the demonomerization of prepolymers containing isocyanate and urethane groups. In one example, a TDI-based prepolymer containing isocyanate and urethane groups is treated by thin-film distillation.

Particularly in the case of prepolymers prepared on the basis of MDI, in particular where a high content of the 2,4′-isomer is present, the separation of the monomers at a conventional thin-film temperature becomes difficult because of the high boiling point of MDI.

In extraction processes or distillations with the use of azeotroping agents, the removed monomer is obtained in a mixture with other materials and must be separated from these in an additional process step before it can be used again.

It is an object of the present invention to provide a simple and gentle process for the demonomerization of prepolymers containing isocyanate and urethane groups, which is particularly suitable for the processing of prepolymers containing isocyanate and urethane groups based on MDI, in particular 2,4′-MDI, and in which the removed monomer is obtained in such a form that it can be reused without further purification.

We have found that this object is achieved by distillation of the prepolymer containing isocyanate and urethane groups by means of a short-path evaporator.

The invention therefore provides a process for the preparation of prepolymers containing isocyanate and urethane groups, comprising the steps of
a) reacting at least one polyisocyanate, in particular at least one diisocyanate, with a less than stoichiometric quantity of at least one compound having at least two isocyanate-reactive hydrogen atoms,
b) distilling the reaction product from step a) by means of a short-path evaporator.

The invention further provides a process for demonomerization of prepolymers containing isocyanate and urethane groups, wherein the prepolymer is subjected to distillation by means of a short-path evaporator after the reaction.

The invention further provides prepolymers containing isocyanate and urethane groups, in particular based on MDI, obtainable by the process of the invention.

The invention further provides prepolymers containing isocyanate and urethane groups based on MDI having an NCO content in the range from 30 to 1% by weight and a content of free MDI of smaller than 0.1% by weight and preferably smaller than 0.05% by weight, based in each case on the weight of the prepolymer.

Short-path evaporators are well known. They are commercially available from, for example, VTA Verfahrenstechnische Anlagen GmbH Deggendorf, QVF Engineering GmbH Leipzig or UCI GmbH Alzenau-Hbrstein. A description of a short-path evaporator can be found, for example, in the article “Kurzweg-Destillation im Labor” by Norbert Kukla, GT Labor-Fachzeitschrift 6/98, pages 616 to 620.

Short-path evaporators are based on the principle of thin-film evaporation. In contrast to thin-film evaporators, where the vapors leaving the liquid are conducted upwardly out of the evaporator and are condensed in an external condenser, short-path evaporators are fitted with a centrally mounted internal condenser. The vapors leaving the liquid film arrive at the internal condenser, condense there and run off downwardly. The large cross-sectional area, which is available for the transport of the vapors from the evaporator to the internal condenser, as well as the small separation between the evaporation and condensation, only result in small pressure drops in the evaporator.

In contrast to the thin-film evaporator, in which a vacuum of only 1 mbar can be achieved, a vacuum of 0.001 mbar is achievable with a short-path evaporator.

By the use of a short-path evaporator for the demonomerization of prepolymers according to the invention, it is possible for the first time to prepare prepolymers containing isocyanate and urethane groups based on MDI with a content of free MDI of smaller than 0.1% by weight, and preferably smaller than 0.05% by weight in each case based on the weight of the prepolymer.

Therefore, the process of the invention is also preferably used in the preparation of those prepolymers containing isocyanate and urethane groups where MDI is the polyisocyanate used in their preparation. Surprisingly, it is possible by means of the process of the invention, to remove substantially all of the MDI from the NCO prepolymer. Through the choice of the conditions for the distillation in the short-path evaporator, it is furthermore possible to carry out the removal of MDI with high selectivity.

The distillation in the short-path evaporator is preferably carried out at from 10 to 10⁻³ mbar, a temperature in the feed vessel of from 30 to 90° C., a temperature in the evaporator of from 50 to 210° C. and a temperature in the condenser of from 15 to 55° C. Under these conditions, optimal removal of unreacted monomers is ensured, without causing damage, in particular degradation, of the prepolymer. The monomeric diisocyanate that has been distilled off is similarly undamaged and can again be converted to prepolymers containing isocyanate and urethane groups without any further purification steps. The industrial process of the process can involve the monomeric diisocyanate that has been distilled off being introduced directly to the storage tank stock reservoir vessel for the diisocyanate for the preparation of the prepolymers.

When carrying out the process in a laboratory, a short-path evaporator is preferably operated at a flow rate of from 1 to 0.1 l/h and a stirrer speed of from 300 to 500 rpm. Scaling can be carried out by those skilled up in the art in the usual way.

In a particularly preferred embodiment of the process according to the invention, process step b) is carried out in a battery of at least two evaporators connected in series, of which at least one is a short-path evaporator. Preference is given to all evaporators of the battery being short-path evaporators. Up to 20 evaporators may be connected in series. The use of a larger number of evaporators makes the process more expensive without providing improved purification. Preference is given to connecting from 2 to 10 and especially from 2 to 5 evaporators in series. The use of a battery is especially advantageous when the prepolymers composed of two isocyanates having different evaporation temperature, for example MDI and TDI are used. Even in the case of diisocyanates which have monomer contents that can only be lowered with difficulty, such as 2,4-MDI, a battery may lead to better purification.

In the evaporators, the same or different pressures and temperatures may be set.

A further advantage in the use of evaporator batteries is that the technical requirements on the vacuum-generating units are lower than in the case of the use of only one evaporator.

The prepolymers containing isocyanate and urethane groups of the invention can, as described above, be prepared by reaction of polyisocyanates with compounds having at least two isocyanate-reactive hydrogen atoms.

Suitable polyisocyanates include, for example, aliphatic, cycloaliphatic and particularly aromatic diisocyanates. The following are specifically named by way of example: aliphatic diisocyanates, such as hexamethylene 1,6-diisocyanate, 2-methylpentamethylene 1,5-diisocyanate, 2-ethylbutylene 1,4-diisocyanate or mixtures of at least two of said C6-alkylene diisocyanates, pentamethylene 1,5-diisocyanate and butylene 1,4-diisocyanate, cycloaliphatic diisocyanates, such as 1-isocyanato-3,3,5-trimethyl-5-isocyanatomethylcyclohexane (isophorone diisocyanate), 1,4-cyclohexane diisocyanate, 1-methyl-2,4- and -2,6-cyclohexane diisocyanate, as well as the corresponding isomer mixtures, 4,4′-, 2,4′- and 2,2′-dicyclo-hexylmethane diisocyanate, as well as the corresponding isomer mixtures and preferably aromatic diisocyanates, such as 1,5-naphthylene diisocyanate (1,5-NDI), 2,4- and 2,6-tolylene diisocyanate (TDI) as well as their mixtures, 2,4′-, 2,2′-, and preferably 4,4′-diphenylmethane diisocyanate (MDI) as well as mixtures of at least two of these isomers, polyphenylpoly-methylene polyisocyanate (polymeric MDI, PMDI) having two or more aromatic systems, mixtures of 2,4′-, 2,2′- and 4,4′-diphenyl-methane diisocyanates and polyphenylpolymethylene polyisocyanates (crude MDI), mixtures of crude MDI and tolylene diisocyanates, polyphenyl polyisocyanates, urethane-modified liquid 4,4′- and/or 2,4′-diphenylmethane diisocyanate and 4,4′-diisocyanatodiphenyl-ethane (1,2). Suitable isocyanate components can also include derivatives of said isocyanates, such as uretdione, urea, biuret or isocyanurate and mixtures thereof.

As described above, the process of the invention works particularly well when employed for making and demonomerizing these prepolymers containing isocyanate and urethane groups where the polyisocyanate is MDI, preferably 4,4′-MDI, 2,4′-MDI and mixtures thereof.

The use of 2,4′-MDI is particularly advantageous, because prepolymers prepared from it usually have a lower viscosity than those prepared from 4,4′-MDI, and can therefore be further processed more easily to give polyurethanes. Such prepolymers are particularly useful as adhesives, sealing compositions and sealants. A particular advantage of the prepolymers based on 2,4′-MDI of the invention is their relatively low viscosity. For this reason, they are easier to handle during further processing and have a higher storage stability than those based on 4,4′-MDI.

Suitable compounds having at least two isocyanate-reactive hydrogen atoms preferably have at least two hydroxyl and/or amino groups in the molecule. Particularly suitable compounds have a molecular weight Mn in the range from 60 to 10 000 g/mol. The compounds having at least two isocyanate-reactive hydrogen atoms are particularly preferably selected from the group consisting of polyfunctional alcohols, polyetheralcohols, polyesteralcohols, polyetherpolyamines, hydroxyl-containing polycarbonates, hydroxyl-containing polyacetals and any mixtures of at least two thereof. Polyfunctional alcohols and polyether-alcohols, as well as mixtures thereof, are particularly preferred.

Examples of suitable polyfunctional alcohols are alkanediols having from 2 to 10, preferably from 2 to 6 carbon atoms, as well as higher alcohols, such as glycerol, trimethylolpropane or pentaerythritol. Furthermore, natural polyols can be used, such as castor oil.

The polyetheralcohols are preferably from di- to octafunctional. Their preparation is usually carried out by addition of alkylene oxides, in particular ethylene oxide and/or propylene oxide, to H-functional starters. The alkylene oxides can be used individually, in sequence or as a mixture. Possible starters include, for example, water, diols, triols, alcohols of higher functionality, sugar alcohols, aliphatic or aromatic amines or aminoalcohols.

Polyetheralcohols having an average molecular weight in the range from 500 to 3 000 g/mol and an average OH-functionality in the range from 2 to 3 are particularly suitable. Particularly preferred starters for the preparation of these polyetheralcohols are propylene glycol and glycerol. Preferred alkylene oxides are ethylene oxide and propylene oxide.

Polyesteralcohols having average molecular weights in the range from 1 000 to 3 000 g/mol and an average OH-functionality in the range from 2 to 2.6 are also preferred. Polyesteralcohols-based on adipic acid are particularly preferred. The preparation of the prepolymers is carried out, as explained, by reaction of the polyisocyanates with the compounds having at least two isocyanate-reactive hydrogen atoms.

Suitable catalysts, which in particular speed the reaction between the NCO groups of the diisocyanates and the hydroxyl groups of the polyalcohols, include the known and conventional strongly basic amines and also organic metal compounds such as titanic esters, iron compounds such as iron(III) acetylacetonate, tin compounds, e.g. tin(II) salts of organic carboxylic acids, or the dialkyltin(IV) salts of organic carboxylic acids or mixtures of at least two of the named catalysts, as well as synergistic combinations of strongly basic amines and organic metal compounds. The catalysts can be used in the usual quantities, for example from 0.002 to 5% by weight, based on the polyalcohols.

The reaction can be carried out continuously or batchwise in the usual reactors, for example the known tubular or stirred-tank reactors, preferably in the presence of the usual catalysts, which speed the reaction of the OH-functional compounds with isocyanate groups, with or without inert solvents, i.e. compounds that do not react with the isocyanates and OH-functional compounds.

It has been determined that, surprisingly, prepolymers based on 2,4′-MDI have a considerably lower product viscosity than analogous prepolymers based on 4,4′-MDI. Viscosity differences of up to 50% were found.

For instance, an NCO prepolymer which was prepared using a polyetheralcohol having a molecular weight of 1 965 g/mol based on propylene glycol and propylene oxide having an NCO content of 5.5% by weight gave a viscosity of 6 366 mP·s at 25° C. from 2,4′-MDI and a viscosity of 10 261 mPa·s from 4,4′-MDI.

An NCO prepolymer which was prepared by using a polyetheralcohol having a molecular weight of 1 965 g/mol based on propylene glycol and propylene oxide (polyol 1) having an NCO content of 4.3% by weight gave a viscosity of 4 283 mP·s at 25° C. from 2,4′-MDI and a viscosity of 12 793 mP·s at 25° C. from 4,4′-MDI.

The subject prepolymers containing isocyanate and urethane groups are customarily used in the preparation of polyurethanes. To this end, the prepolymers containing isocyanate and urethane groups are reacted with compounds that can react with isocyanate groups. The compounds that can react with isocyanate groups include, for example, water, alcohols, amines or compounds having mercapto groups. The polyurethanes can be used as foaming agents, coatings, adhesives, in particular melt-applied adhesives, paints, as well as compact or cellular elastomers. Where they are used as sealants or adhesives, the curing to give finished polyurethanes is carried out in the simplest case by the action of the moisture in air.

The prepolymers of the invention may be useful for the preparation of polyurethane films, in particular those for the food sector. It is not only for that but also for use as melt-applied adhesives, in particular hot-melt adhesives, coatings or seals that prepolymers based on 2,4′-MDI are particularly suitable.

The invention is illustrated by the following examples.

Investigations were carried out on prepolymers containing isocyanate and urethane groups based on methylene di(phenyl isocyanate) or tolylene diisocyanate. The prepolymers were synthesized by known methods at 80° C. in an experimental apparatus, which consisted of a heatable glass reactor equipped with stirrer, temperature gage, reflux condenser, inert gas inlet (nitrogen) and external heating (table 1).

TABLE 1

| | Prepolymer 1 | Prepolymer 2 | Prepolymer 3 |
|---|---|---|---|
| Composition | 4,4′-MDI | 2,4′-MDI | Lupranat ® |
| | Polyol 1 | Polyol 1 | T 80 A*) Polyol 1 |
| NCO content | 5.5 | 5.2 | 6.3 |
| [% by weight] | | | |
| Viscosity at | 10 261 | 6 400 | 2 560 |
| 25_C. [mPaVs] | | | |
| Diisocyanate | 7.6 | 6.8 | 6.5 |
| monomer content | | | |
| [% by weight]**) | | | |

*)Lupranat ® T 80 A (BASF; 80% of 2,4′-tolylene diisocyanate and 20% of 2,6′-tolylene diisocyanate)
**)determined by HPLC

To remove the monomers, 1 000 g of each prepolymer according to table 1 were introduced to the stock reservoir vessel of a short-path evaporator apparatus of the type VKL 70 from VTA Verfahrenstechnische Anlagen GmbH Deggendorf, which had a evaporator area of 0.04 m² and was set to a throughput of 0.1 to 2 l/h, and heated to 80° C. (prepolymer 1) or 60° C. (prepolymer 2). The evaporator and condenser were preheated to the target temperature given in table 2. Once stirring had commenced, the vacuum had been set and the intended flow rate had been attained, the monomer-containing prepolymer was fed from the stock reservoir vessel through the short-path evaporator; Prepolymers having a remaining monomer content of smaller than 0.05% by weight were prepared by the process described. Furthermore, a monomer was recovered that had a purity of greater than 97%. The process of the invention for the preparation of prepolymers provides an isocyanate monomer that can be used again for the preparation of prepolymers without an additional processing step.

TABLE 2

| | Prepolymer 1 | Prepolymer 3 |
|---|---|---|
| Distillation parameters | | |
| Pressure [mbar] | 0.03 | 0.02 |
| Flow rate [l/h] | 0.17 | 0.27 |
| Stirrer speed [rev/min] | 415 | 410 |
| Stock reservoir vessel temperature | 80 | 60 |
| [° C.] | | |
| evaporator temperature [° C.] | 120 | 80 |
| Condenser temperature [° C.] | 50 | 20 |
| NCO content [% by weight] | | |
| Before short-path distillation | 5.5 | 6.3 |
| After short-path distillation | 2.6 | 3.5 |
| Isocyanate monomer content**) [%] | | |
| Before short-path distillation | 7.6 | 6.5 |
| After short-path distillation | 0.02 | 0.01 |
| Viscosity of prepolymer at | | |
| 25° C. [mPa · s] | | |
| Before short-path distillation | 10 261 | 2 560 |
| After short-path distillation | 23 483 | 5 385 |
| Color number [iodine] | | |
| Before short-path distillation | 0.1 | 0.1 |
| After short-path distillation | 0.2 | 0.1 |

**)Determined by HPLC

In table 3, the monomer removal by means of a single evaporator and by means of an evaporator battery are compared. In example 1, the prepolymers 4 and 5 are prepared from 2,4-MDI and polyol 1. After the preparation, prepolymer 4 had an NCO content of 5.3% by weight, a viscosity of 25° C. of 7887 mPa·s and a diisocyanate monomer content of 6.8% by weight. After the preparation, prepolymer 5 had an NCO content of 5.6% by weight, a viscosity of 6768 mPa·s at 25° C. and a content of monomer diisocyanate of 7.4% by weight.

TABLE 3

| | Prepolymer 4 | Prepolymer 5 |
|---|---|---|
| Distillation parameters | | |
| Pressure [mbar] | 0.01 | 0.5//0.07 |
| Flow rate [l/h] | 160 | 160//60 |
| Stirrer speed [rev/min] | 410 | 410 |
| Stock reservoir vessel temperature | 80 | 80 |
| [° C.] | | |
| Evaporator 1 temperature [° C.] | 120 | 120 |
| Evaporator 2 temperature [° C.] | — | 120 |
| Condenser 1 temperature [° C.] | 50 | 50 |
| Condenser 2 temperature [° C.] | — | 50 |
| NCO content [% by weight] | | |
| Before the distillation | 5.3 | 5.6 |
| After evaporator unit 1 | 3.6 | 3.9 |
| After evaporator unit 2 | — | 3.3 |
| Isocyanate monomer content | | |
| [% by weight] | | |
| Before distillation | 6.8 | 7.4 |
| After evaporator unit 1 | 0.10 | 2.53 |
| After evaporator unit 2 | — | 0.03 |
| Viscosity at 25° C. [mPa · s] | | |
| Before distillation | 7868 | 6768 |
| After evaporator unit 1 | 12941 | 8188 |
| After evaporator unit 2 | — | 11724 |
| Color number [iodine] | | |
| Before distillation | 9.0 | 2.4 |
| After evaporator unit 1 | 10.8 | 5.6 |
| After evaporator unit 2 | — | 7.4 |

The prepolymer 5 was demonomerized in an evaporator battery having two evaporator units connected in series:
evaporator unit 1: short-path evaporator
evaporator unit 2: short-path evaporator

Both short-path evaporators were of the same type. The use of an evaporator battery instead of a single evaporator unit achieved a distinct improvement in the monomer removal.

As a comparison, monomer separation was carried out by solvent extraction and high-pressure extraction with supercritical carbon dioxide.

### COMPARATIVE EXAMPLE A

Demonomerization of prepolymers by extraction with n-hexane in a Kutscher-Steudel extractor perforator

The results are recorded in table 4.

TABLE 4

| | 4,4′-MDI | 2,4′-MDI |
|---|---|---|
| Polyetheralcohol | Polyol 1 | |
| NCO content [% by weight] | | |
| Before extraction | 5.5 | 5.6 |
| After extraction | 3.0 | 3.3 |
| MDI monomer content [%]**) | | |
| Before extraction | 7.3 | 7.6 |
| After extraction | 1.0 | 0.6 |
| Viscosity of the prepolymer at 25° C. | | |
| [mPa · s] | | |
| Before extraction | 7 947 | 6 366 |
| After extraction | 21 096 | 10 517 |
| Color number [iodine] | | |
| Before extraction | 1.0 | 2.4 |
| After extraction | 8.8 | 14.0 |

**)determined by HPLC

The solvent extraction had the following disadvantages:

The extractive separation of high. MDI monomer contents required long extraction times, in which the MDI prepolymer was exposed to thermal stress. This was reflected in the increase in the color number.

The monomer content was appreciably above 0.1% by weight.

### COMPARATIVE EXAMPLE B

Demonomerization of MDI prepolymers through high-pressure extraction by means of supercritical carbon dioxide

Parameters:

| | |
|---|---|
| Ratio of prepolymer to carbon dioxide | 1:7 |
| Temperature in extractor | 63° C. |
| Pressure in extractor | 220 bar |
| Temperature in monomer separator | 60° C. |
| Pressure in monomer separator | 55 bar |
| Temperature in carbon dioxide condenser | 13° C. |
| Pressure in carbon dioxide condenser | 56 bar |

Comparison of the two processes: extraction with supercritical carbon dioxide and short-path evaporator distillation

The prepolymers were prepared by the general method from 4,4′-MDI and polyol 1.

| | High-pressure extraction | Short-path |
|---|---|---|
| | with supercritical carbon | evaporator |
| | dioxide | distillation |
| NCO content [% by weight] | | |
| Before operation | 5.4 | 5.5 |
| After operation | 2.7 | 2.9 |
| MDI monomer content [%]**) | | |
| Before operation | 7.7 | 7.6 |
| After operation | 0.28 | 0.04 |
| Viscosity of prepolymer | | |
| at 25° C. [mPa · s] | | |
| Before operation | 11 928 | 10 261 |
| After operation | 20 472 | 18 392 |
| Color number [iodine] | | |
| Before operation | 0.1 | 0.1 |
| After operation | 0.5 | 0.2 |

**)determined by HPLC

Disadvantage of the extraction with supercritical carbon dioxide: The solubility of the carbon dioxide used as an extractant is up to 0.4% by weight in the MDI prepolymer and up to 0.1% by weight in the MDI monomer. This normally makes an additional step necessary for the degasification of the product.

1. A process for the preparation of prepolymers containing isocyanate and urethane groups, comprising the steps of
a) reacting 2,4′-diphenylmethane diisocyanate or mixtures of 2,4′-diphenylmethane diisocyanate and 4,4′-diphenylmethane diisocyanate or mixtures of 2,4′-, 2,2′- and 4,4′-diphenylmethane diisocyanate and polyphenylpolymethylene polyisocyanates with a less than stoichiometric quantity of a polyether alcohol,
b) removing the monomeric diisocyanates by distilling the reaction product from step a) by means of a short-path evaporator.

2. A process as claimed in claim 1, wherein the distillation in step b) is carried out in an evaporator battery comprising at least 2 evaporators connected in series.

3. A process as claimed in claim 1, wherein step b) is carried out at a pressure of from 10 to 10⁻³ mbar.

4. A process as claimed in claim 1, wherein the evaporator comprises a vaporizer and a condenser and step b) is carried out at a temperature in the vaporizer of from 50 to 210° C. and a temperature in the condenser of from 15 to 55° C.

5. Prepolymers containing isocyanate and urethane groups, made in accordance with a process as claimed in any of claims 1 to 4.

6. Prepolymers containing isocyanate and urethane groups as claimed in claim 5, comprising monomeric diisocyanates at less than or equal to 0.1% by weight, based on the weight of the prepolymer.

7. Prepolymers containing isocyanate and urethane groups as claimed in claim 5, comprising monomeric diisocyanates at less than 0.05% by weight, based on the weight of the prepolymer.

8. and 9. (Cancelled).

10. A method of preparing polyurethanes comprising reacting the prepolymers of claim 5 with an isocyanate-reactive component.

11. A method of preparing melt-applied adhesives, packaging films, coatings or sealants, comprising reacting the prepolymers of claim 5 with an isocyanate-reactive component.
